(19) United States
(12) Patent Application Publication
(10) Pub. No.: US 2008/0217956 A1
(43) Pub. Date: Sep. 11, 2008

(54) Motor Vehicle and Door Lock for a Door of a Motor Vehicle

(75) Inventors: Jorg Gschweng, Mainz (DE); Ingobert Lassrich, Trebur (DE); Rolf Lohr, Morfelden-Walldorf (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/064,438

(22) PCT Filed: Jul. 20, 2006
(86) PCT No.: PCT/EP2006/007159

§ 371 Date: Feb. 21, 2008

(30) Foreign Application Priority Data
Aug. 26, 2005 (DE) 10 2005 040 775.7

(51) Int. Cl. B60J 5/00

(52) U.S. Cl. 296/146.1; 292/201

(57) ABSTRACT

The present invention relates to a motor vehicle having a driver door, a passenger door, and two rear doors. Each of the doors has an internal opening device for opening the corresponding door from the interior of the motor vehicle using an assigned electrical drive, and an external opening device for opening the corresponding door from outside the motor vehicle using an assigned electrical drive. The electrical drives are each provided to lock and unlock the opening device assigned thereto.

### CROSS-REFERENCE TO RELATED APPLICATIONS

This application is a U.S. National-Stage entry under 35 U.S.C. § 371 based on International Application No. PCT/EP2006/007159, filed Jul. 20, 2006, which was published under PCT Article 21(2) and which claims priority to German Application No. DE 10 2005 040 775.7, filed Aug. 26, 2005.

### TECHNICAL FIELD

The present invention relates to a motor vehicle having a driver door, a passenger door, and two rear doors, and a door lock for at least one of the doors of a motor vehicle.

### BACKGROUND

Motor vehicles may be equipped with an electrical locking system and an additional electrical theft deterrence system. The doors of such motor vehicles comprise door locks each having two electric drives.

If the motor vehicle is unlocked, all doors may be opened both from the inside and also from the outside. If the motor vehicle is put into its locking mode, one of the electrical drives locks the door from the outside. The door may then no longer be opened from the outside, but may still be opened from the inside. If the motor vehicle is put into its theft deterrence mode, the other electrical drives deactivate the entire door lock, so that the door may not be opened from the inside or the outside.

Motor vehicles additionally typically have a child safety lock so that, when it is activated, the rear doors may never be opened from the inside. Common child safety locks are mechanically actuated, in that the functions of the door inner handles are deactivated using levers in the rear doors. If the vehicle comprises an electrical child safety lock, the functionality of the child safety lock is implemented using one additional electrical drive per rear door.

In view of the foregoing, it is desirable to provide conditions for a motor vehicle having an electrical child safety lock, so that as few electrical drives as possible are used for locking the doors. Furthermore, other described features, characteristics and objects will become more apparent from the subsequent summary, detailed description, and appended claims, taken in conjunction with the accompanying drawings and foregoing background.

### SUMMARY

At least one object of the present invention is achieved by a door lock for a door of a motor vehicle, having a locking mechanism having a forked latch to be situated on the door and a pawl to be situated on a door frame of the motor vehicle to be assigned to the door, using which the door is closable in the installed state of the door lock, an internal opening device, using which, in the installed state of the door lock, a mechanical internal actuating device, situated on the interior side of the door, is coupled to the forked latch in a first operating state and decoupled therefrom in a second operating state, so that the locking mechanism may be opened using the internal actuating device in the first operating state and may not be opened in the second operating state, an external opening device, using which, in the installed state of the door lock, a mechanical external actuating device situated on the exterior side of the door is coupled to the forked latch in a first operating state and is decoupled therefrom in a second operating state, so that the locking mechanism may be opened using the external actuating device in the first operating state and may not be opened in the second operating state, a first electrical drive assigned to the internal opening device, using which the internal opening device is switchable between its two operating states independently of the operating state of the external opening device, and a second electrical drive assigned to the external opening device, using which the external opening device is switchable between its two operating states independently of the operating state of the internal opening device.

An exemplary embodiment of the present invention decouples the internal opening device from the external opening device. It is thus possible to activate the two electrical drives in such a way that a vehicle door in which the door lock according to the present invention is installed may be operated in the following operating states, for example:

The two electrical drives may be activated in such a way that the two opening devices are in their first operating states. The door may then be opened both from the inside and also from the outside, the door is thus completely unlocked.

The two electrical drives may be activated in such a way that the internal opening device is in its first operating state and the external opening device is in its second operating state. The door may then only be opened from the inside, but is locked from the outside. This corresponds to the locking mode.

The two electrical drives may be activated in such a way that the two opening devices are in their second operating states. The door is then locked both from the inside and also from the outside and may not be opened from the inside or the outside. Such an operating state corresponds to the theft deterrence system.

The two electrical drives may be activated in such a way that the internal opening device is in its second operating state and the external opening device is in its first operating state. The door may then only be opened from the outside, but is locked from the inside. A child safety lock may thus be implemented.

If the internal opening device has an internal lever chain and/or the external opening device has an external lever chain, as provided according to one variant of the door lock according to the present invention, the first electrical drive and/or the second electrical drive may be activated in such a way that for the particular second operating state, the corresponding electrical drive interrupts a connection of the particular lever chain between the corresponding actuating device and the forked latch.

An internal actuating device is, for example, an inside door handle situated on the inside of the door and an external actuating device is, for example, an outside door handle situated on the outside of the door.

At least another object of the present invention is also achieved by a motor vehicle having a driver door, a passenger door, and two rear doors, each of the doors having an internal opening device for opening the corresponding door from the inside of the motor vehicle using an assigned electrical drive and an external opening device for opening the corresponding door from outside the motor vehicle using an assigned electrical drive, and the electrical drives each being provided to lock and unlock the opening device assigned thereto, and the motor vehicle being set up in such a way that, using the electrical drives, it is operable in a first mode, in which the internal and external opening devices are unlocked, it is operable in a second mode, in which the internal opening devices are unlocked and the external opening devices are locked, and it is operable in a third mode, in which the internal and the external opening devices are locked, and the motor vehicle is additionally operable in a child safety lock mode, in which, using the electrical drives assigned to the internal opening devices of the rear doors, the internal opening devices of the rear doors are always locked independently of the first, second, and third modes.

In accordance with another exemplary embodiment of the present invention is, a motor vehicle having an electrical theft deterrent system, to use the electrical drives which are assigned to the internal opening devices of the rear doors not only for the theft deterrence system, but rather also for the child safety lock. This is achieved in that the motor vehicle according to the exemplary embodiment is implemented in such a way that in the child safety lock mode, the electrical drives assigned to the internal opening devices of the rear doors always lock the internal opening devices of the rear doors independently of whether the motor vehicle is in its first, second, or third mode. The second mode corresponds to the locking mode and the third mode corresponds to the theft deterrence mode. Through the activation of the electrical drives assigned to the internal opening devices, additional electrical drives for the child safety lock in the rear doors may be dispensed with.

The child safety lock mode may be activated or deactivated using a suitable actuating device, such as a switch or button. The changeover device is preferably located in the area of the driver seat of the motor vehicle. If the rear doors of the motor vehicle comprise activatable electrical window levers in the area of the particular rear doors, which are deactivatable using a switch device in the area of the driver seat, the child safety lock mode is activated simultaneously with the activation of the window levers using the switch device.

If the motor vehicle according to the present invention comprises a wireless remote control, using which the motor vehicle may be put into its first, second, and third modes, the remote control may additionally be implemented according to a variant of the motor vehicle in such a way that the child safety lock mode is activatable and/or deactivatable therewith.

### BRIEF DESCRIPTION OF THE DRAWINGS

The present invention will hereinafter be described in conjunction with the following drawing figures, wherein like numerals denote like elements, and

FIG. 1 shows a passenger automobile having four doors;

FIG. 2 through FIG. 5 show a door lock in various operating states; and

FIG. 6 shows a key having integrated remote control.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

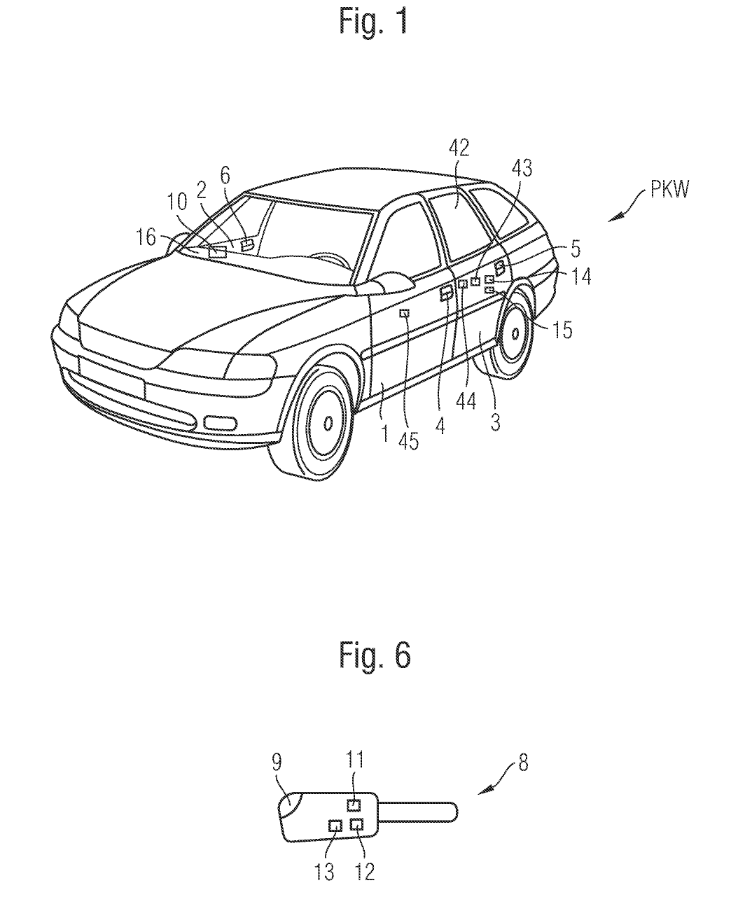

FIG. 1 shows a passenger automobile PKW having a driver door 1, a passenger door 2, a first rear door 3, and a second rear door (not shown in greater detail in FIG. 1). Each of the doors 1 through 3 has an outside door handle and an inside door handle. Using the outside door handle, the corresponding door may be opened from the outside, and using the inside door handle, the corresponding door may be opened from the inside. Only the outside door handles 4 and 5 of the driver door 1 and the first rear door 3 and the inside door handle 6 of the passenger door 2 are shown in FIG. 1.

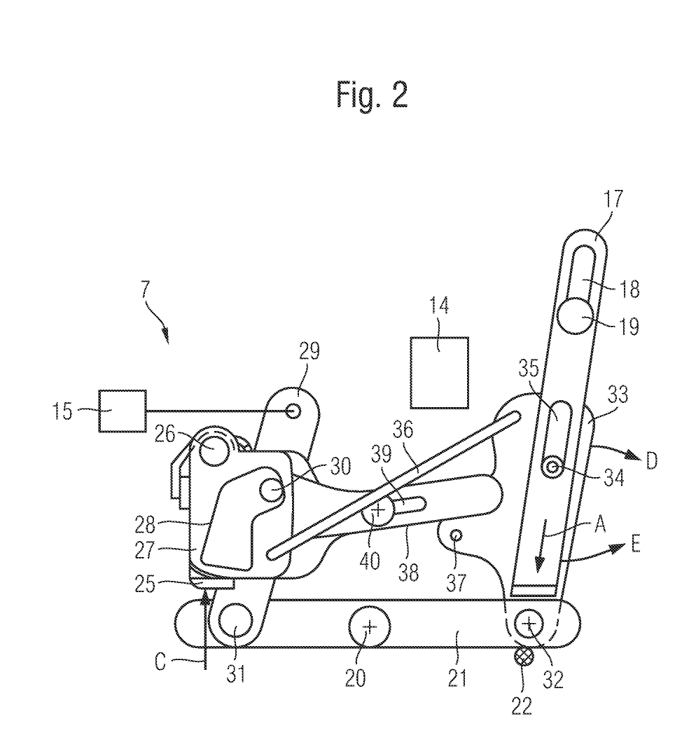

Each of the doors 1 through 3 and the second rear door (not shown) comprises a door lock, which is coupled to the corresponding inside door handle 6 or outside door handles 4 and 5. In the case of the present exemplary embodiment, the door lock 7 of the rear door 3 is shown of the door locks in FIGS. 2 through 5. The door locks of the remaining three doors are implemented essentially identically to the door lock 7 of the rear door 3.

In the case of the present exemplary embodiment, the four doors of the passenger automobile PKW may be locked and unlocked wirelessly using a key 8 shown in FIG. 6. The key 8 comprises a transmitter device 9 generally known to those skilled in the art, which may communicate in a generally known way with a control device 10 of the passenger automobile PKW situated below the dashboard 16 of the passenger automobile PKW.

In the case of the present exemplary embodiment, the key 8 also comprises three buttons 11, 12, and 13, which are connected to the transmitter device 9 in a way which is not shown. Using the key 8, an operator (not shown in greater detail in the figures) may lock and unlock the passenger automobile PKW. Furthermore, in the case of the present exemplary embodiment, the operator may activate and deactivate a theft deterrence system and a child safety lock using the key 8.

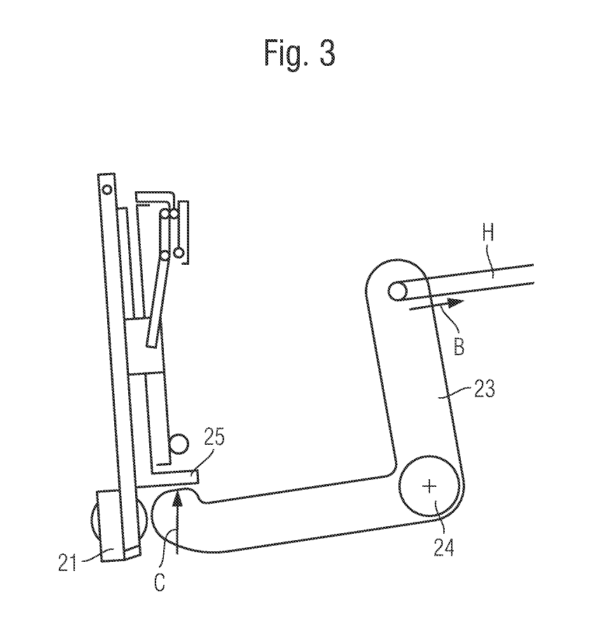

In the basic state, the passenger automobile PKW is unlocked, i.e., all four doors may be opened using both their outside door handles and also their inside door handles. The basic state of the door lock 7 is illustrated in FIGS. 2 and 3.

In the case of the present exemplary embodiment, the door lock 7 comprises two electrical servomotors 14 and 15, which are electrically connected to the control device 10 in a way not shown in greater detail. The control device 10 is also electrically connected to electrical servomotors of the remaining door locks. In the case of the present exemplary embodiment, the servomotor 14 is provided for locking the rear door 3 from the outside and the servomotor 15 is provided for locking the rear door 3 from the inside.

In the case of the present exemplary embodiment, the door lock 7 comprises an actuating lever 17, which is coupled to the outside door handle 5 of the rear door 3 by a lever (not shown in the figures). The actuating lever 17 comprises an oblong hole 18, via which the actuating lever 17 is mounted so it is displaceable in the direction of the arrow A using a pin 19.

If the operator (not shown in the figures) actuates the outside door handle 5 of the rear door 3 to open the door from the outside, the actuating lever 17 is pressed in the direction of the arrow A via the lever coupled to the outside door handle 5. The actuating lever 17 thus presses against a trigger lever 21 of the door lock 7, mounted so it is rotatable on a rotation point 20, by which the trigger lever is rotated on one end in the direction of the arrow A and on its other end in the direction of the arrow C. The trigger lever 21 is in turn operationally linked to a locking mechanism (not shown in the figures), which is generally known to those skilled in the art, of the door lock 7 via a transmission point 22. In a generally known way, the locking mechanism comprises a forked latch (not shown in greater detail), which is fastened to the rear door 3, and which works together with a closing element (also not shown) of the locking mechanism, which is fastened to a door frame of the passenger automobile PKW assigned to the rear door 3. The trigger lever 21 is pivoted in regard to its rotation point 20 by the movement of the actuating lever 17 in the direction of the arrow A, and conducts a force to the transmission point 22, by which the locking mechanism of the door lock 7 releases the rear door 3, by which the door may be opened.

In the case of the present exemplary embodiment, the door lock 7 also comprises an L-shaped internal actuating lever 23, shown in FIG. 3, which is mounted so it is rotatable using a rotation point 24. The internal actuating lever 23 is coupled on one end using a lever (only partially shown in FIG. 3) to the inside door handle of the rear door 3. If the operator (not shown in the figures) actuates the inside door handle of the rear door 3 to open the door from the inside, the internal actuating lever 23 is pulled via the lever H in the direction of the arrow B, upon which it is rotated in relation to the rotation point 24 in such a way that the end of the internal actuating lever 23 distal from the lever H is pressed in the direction of the arrow C.

Through the movement of the L-shaped internal actuating lever 23 in the direction of the arrow C, it also presses a displaceably mounted angled profile 25 of the door lock 7 in the direction of the arrow C.

The angled profile 25 has a rod 26, on which a crank plate 27 having an L-shaped oblong hole 27 is mounted so it is rotatable. Furthermore, in the case of the present exemplary embodiment, the door lock 7 comprises a displaceably mounted connecting lever 29 having a transmission rod 30. The transmission rod 30 runs in the L-shaped oblong hole 28 of the crank plate 27. The connecting lever 29 is also coupled to the trigger lever 2 via a coupling point 31.

If the inside door handle of the rear door 3 is actuated, the angled profile 25 and thus the crank plate 27 are displaced in the direction of the arrow C via the internal actuating lever 23. With the displacement of the angled profile 25 in the direction of the arrow C, the connecting lever 29 is also displaced in the direction of the arrow C via the coupling of the transmission rod 30 to the crank plate 27. By the coupling of the connecting lever 29 to the trigger lever 21 via the coupling point 31, the trigger lever 21 is rotated by the displacement of the connecting lever 29 in relation to the rotation point 20, by which the trigger lever 21 in turn acts via the transmission point 22 on the locking mechanism of the door lock 7, by which this releases the rear door 3. The rear door may then be opened.

To lock the passenger automobile PKW, the person presses the button 11 of the key 8. The transmitter device 9 of the key 8 then transmits a signal to the control device 10. On the basis of this signal, the control device 10 activates the electrical servomotor 14 of the door lock 7 and the corresponding electrical servomotors of the remaining door locks in such a way that the servomotor 14, via a towing lever (not shown), pivots a control plate 33 of the door lock 7, coupled via a coupling point 32 to the trigger lever 21, in the direction of the arrow D. The control plate 33 comprises a rod 34, which in turn runs in a further oblong hole 35 of the actuating lever 17.

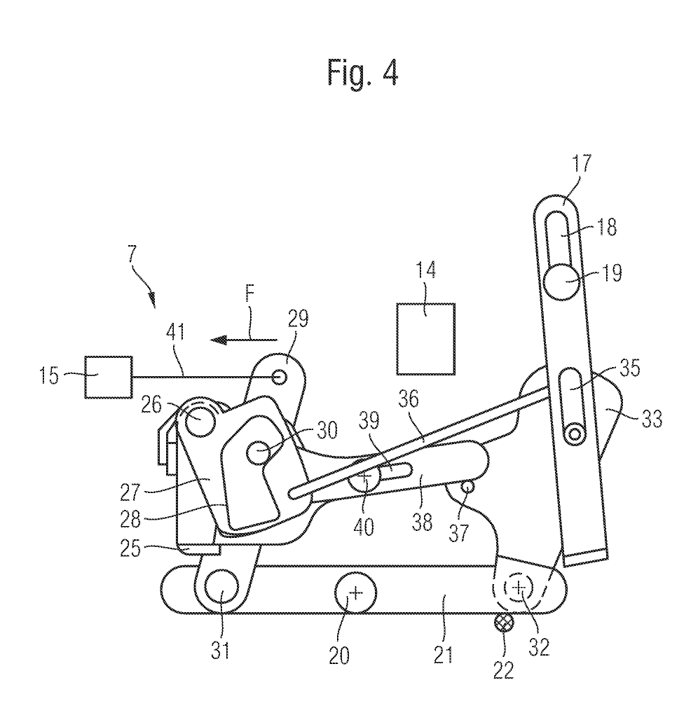

Due to the pivoting of the control disk 33 in the direction of the arrow D caused by the servomotor 14, the control disk 33 pivots the actuating lever 17 in relation to the pin 19, on which the actuating lever 17 is mounted so it is rotatable, via its rod 34 in the direction of the arrow E into a position shown in FIG. 4.

In the case of the present exemplary embodiment, the control plate 33 is also coupled via a connecting rod 36 to the crank plate 27. Due to the movement of the control plate 33 caused by the servomotor 17, the connecting rod 36 pivots the crank plate 27 in relation to the rod 26 into a position shown in FIG. 4.

Due to the position of the actuating lever 17 shown in FIG. 4, it may no longer act on the trigger lever 21 upon actuation of the outside door handle 5, by which the rear door 3 is locked from the outside. The door locks of the remaining doors are activated similarly by the control device 10, so that these doors are also locked from the outside.

If one of the doors locked from the outside, and particularly the rear door 3, which is locked from the outside, is opened from the inside, by actuating the inside door handle of the rear door 3, the lever H is moved in the direction of the arrow B shown in FIG. 2, by which the angled profile 25 is displaced in the direction of the arrow C. By the displacement of the angled profile 25 in the direction of the arrow C, the crank plate 27 is also displaced in the direction of the arrow C. The crank plate 27, however, is coupled via the transmission rod 30 to the connecting lever 29 in the position shown in FIG. 4. The connecting lever 29 is thus also moved in the direction of the arrow C by the movement of the crank plate 27 in the direction of the arrow C. Because the connecting lever 29 is coupled via the coupling point 31 to the trigger lever 21, however, the trigger lever 21 is pivoted in relation to its pivot point 20 in such a way that it acts on the transmission point 22. The forked latch of the locking mechanism of the door lock 7 thus releases the door lock 7, by which the rear door 3 may be opened.

In the case of the present exemplary embodiment, the door lock 7 also comprises a safety lever 38 having an oblong hole 39, which works together with a rotation point 40. The safety lever 38 is also coupled at one end to the transmission rod 30. A force is transmitted via the transmission rod 30 to the safety lever 38 by the displacement of the crank plate 27. In the case of the present exemplary embodiment, the control plate 33 additionally comprises a lug 37. The lug 37 of the control plate 33 in turn works together with the safety lever 38 in such a way that the force which acts on the safety lever 38 via the transmission rod 30 because of the displacement of the crank plate 27 is transmitted to the control plate 33. The crank plate 33 connected via the connecting rod 36 thus moves into the position shown in FIG. 2, in which the outside door handle of the rear door 3 is unlocked.

Furthermore, the locking mechanisms of the doors, i.e., also the locking mechanism (not shown in greater detail) of the door lock 7, are each provided with a sensor (also not shown), which is electrically connected to the control device 10, and which recognizes when a locking mechanism is actuated, i.e., when a door is opened. If one of the locking mechanisms is actuated, the control device activates the particular electrical actuator of the door locks which is coupled to the control plate of the corresponding door lock, so that the remaining doors are also unlocked from the outside.

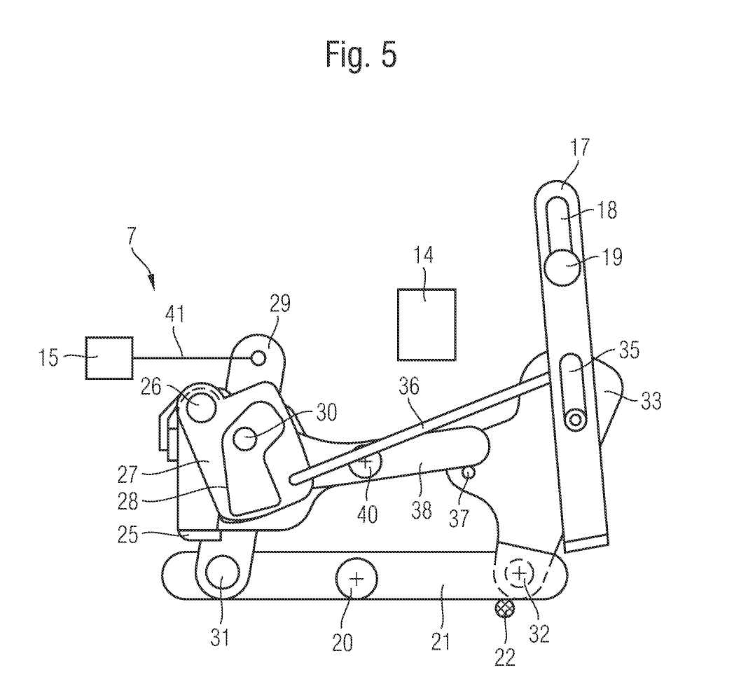

The passenger automobile PKW is additionally equipped with a theft deterrence system. To activate the theft deterrence system, the person first presses the button 11 to lock the passenger automobile PKW from the outside, as described above and shown in FIG. 4. To activate the theft deterrence system, the operator presses the button 11 a second time, so that the transmitter device 9 of the key 8 transmits a further signal to the control device 10. On the basis of this further signal, the control device 10 activates the electrical servomotor 15 of the door lock 7 and the corresponding electrical servomotors of the remaining door locks in such a way that the servomotor 15 pivots the locking lever 29 via a lever 41 in the direction of the arrow F shown in FIG. 4 in relation to the coupling point 31 into a position shown in FIG. 5. If the inside door handle of the rear door 3 is actuated, the angled profile 25 and thus the crank plate 27 are displaced in the direction of the arrow C via the inside actuating lever 23. With activated theft deterrence system, the connecting lever 29 is located in the position shown in FIG. 5, in which the transmission rod 30 runs freely in the L-shaped oblong hole 28 upon a movement of the crank plate 27. As a result, the crank plate 33 is no longer coupled via the transmission rod 30 to the connecting lever 29, because of which the connecting lever 29 does not move the trigger lever 21 upon the movement of the crank plate 33 in the direction of the arrow C. Therefore, no force also acts on the transmission point 22 and the locking mechanism does not release the rear door 3. In addition, the locking lever 29 is connected via the transmission rod 30 to the safety lever 38. With activated theft deterrence system, this lever is moved into a position shown in FIG. 5, in which it is no longer operationally linked to the control plate 33 via its lug 37. Upon actuation of the inside door handle of the rear door 3, the safety lever 38 may thus not exert a force on the lug 37 of the control plate 33, because of which the rear door 3 also remains locked from the outside.

To unlock the passenger automobile PKW again, the operator presses the button 12. The transmitter device 9 of the key 8 then transmits a further signal to the control device 10. On the basis of this further signal, the transmitter device 10 activates the control motors 14 and 15 in such a way that the doors are unlocked both from the outside and also from the inside.

The passenger automobile PKW is also equipped with a child safety lock for the rear doors. This may be activated and deactivated using the button 13 of the key 8.

If the child safety lock is activated, the connecting lever 29 is located in the position shown in FIG. 5 independently of whether the passenger automobile is locked or unlocked from the outside. With activated child safety lock, the connecting lever 29 is thus situated in relation to the crank plate 27 in such a way that the transmission rod 30 runs freely in the L-shaped oblong hole 28 upon a movement of the crank plate 27. As a result, the crank plate 33 is no longer coupled to the connecting lever 29 via the transmission rod 30. The connecting lever 29 is thus not also moved in the event of a movement of the crank plate 33 in the direction of the arrow C caused by an actuation of the inside door handle of the rear door 3. The trigger lever 21 is thus also not moved, because of which the locking mechanism of the door lock 7 does not release the rear door 3.

The door lock of the further rear door is activated accordingly with activated child safety lock.

To turn off the child safety lock again, the operator may press the button 13 of the key 8 once again. The transmitter device 9 of the key 8 then transmits a corresponding signal to the control device 10 and the inside door handles of the two rear doors 3 are unlocked again.

In the case of the present exemplary embodiment, each of the four doors 1, 2, 4 additionally comprises an electrical power-window unit. The electrical power-window unit is controlled in each case using a switch, which then activates an electrical drive coupled to the corresponding window in a generally known way.

The windows of the two rear doors, of which only one window 42 of the rear door 3 is shown in FIG. 1, may each be opened and closed using a switch situated on the corresponding rear door. Only the switch 43 of the rear door 3 and the electrical drive 44 assigned to the switch 43 are shown in FIG. 1. Moreover, the two electrical drives of the power-window units of the two rear doors are electrically connected to the control device 10 in a way which is not shown.

Furthermore, in the case of the present exemplary embodiment, the passenger automobile PKW comprises a switch 45, which is situated on the driver door 1 and is reachable from the driver seat. The switch 45 is in turn connected to the control device 10 in a way which is not shown. The switch 45 has two positions in the case of the present exemplary embodiment.

In its first position, it causes the control device 10 to deactivate the two switches 43 of the power-window units of the rear doors 3 situated on the rear doors 3. The child safety lock is activated simultaneously in the case of the present exemplary embodiment.

In its second position, a causes the control device 10 to reactivate the two switches 43 of the power-window units of the rear doors 3 situated on the rear doors 3. The child safety lock is deactivated again simultaneously in the case of the present exemplary embodiment.

Although the present invention was described above on the basis of a preferred exemplary embodiment, it is not restricted thereto, but rather is modifiable in manifold ways.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A motor vehicle comprising a driver door, a passenger door, and two rear doors, wherein each of the doors has an internal opening device for opening the corresponding door from the interior of the motor vehicle using an assigned electrical drive, and an external opening device for opening the corresponding door from outside the motor vehicle using an assigned electrical drive, and the electrical drives are each provided to lock and unlock the opening device assigned thereto, and the motor vehicle is set up in such a way that, using the electrical drives,
it is operable in a first mode, in which the internal and external opening devices are unlocked
it is operable in a second mode, in which the internal opening devices are unlocked and the external opening devices are locked and
it is operable in a third mode, in which the internal and the external opening devices are locked
and the motor vehicle is additionally operable in a child safety lock mode, in which the internal opening devices of the rear doors are always locked using the electrical drives assigned to the internal opening devices of the rear doors, independently of the first, second, and third modes.

2. The motor vehicle according to claim 1, whose rear doors comprise activatable electrical power-window units in the area of the particular rear doors, which are deactivatable using a switch device in the area of the driver seat, and the motor vehicle is set up in such a way that upon deactivation of the power-window units using the switch device the child safety lock mode is activated.

3. The motor vehicle according to claim 1, which comprises a wireless remote control, using which the motor vehicle may be put into its first, second, and third modes.

4. The motor vehicle according to claim 3, wherein the wireless remote control is additionally implemented in such a way that the child safety lock mode is activatable and/or deactivatable.

5. A door lock for a door of a motor vehicle, comprising:
a locking mechanism having a forked latch, to be situated on the door, and a closing element, which works together with the forked latch and is to be situated on a door frame of the motor vehicle assigned to the door, using which the door is closable in the installed state of the door lock;
an internal opening device, which, in the installed state of the door lock, a mechanical internal actuating device situated on the interior of the door is coupled to the forked latch in a first operating state and is decoupled therefrom in a second operating state, so that, using the internal actuating device, the locking mechanism may be opened in the first operating state and may not be opened in the second operating state;
an external opening device, using which, in the installed state of the door lock, a mechanical external actuating device situated on the exterior of the door is coupled to the forked latch in a first operating state and is decoupled therefrom in a second operating state, so that, using the external actuating device, the locking mechanism may be opened in the first operating state and may not be opened in the second operating state;
a first electrical drive assigned to the internal opening device, using which the internal opening device is switchable between its two operating states independently of the operating state of the external opening device; and
a second electrical drive assigned to the external opening device, using which the external opening device is switchable between its two operating states independently of the operating state of the internal opening device.

6. The door lock according to claim 5, wherein the internal opening device has an internal lever chain and/or the external opening device has an external lever chain.

7. The door lock according to claim 6, wherein the first electrical drive interrupts a connection of the internal lever chain between the internal actuating device and the forked latch in the second operating state.

8. The door lock according to claim 6, wherein the second electrical drive interrupts a connection of the external lever chain between the external actuating device and the forked latch in the second operating state.

9. The door lock according to claim 5, wherein the internal actuating device is an inside door handle situated on the interior of the door and/or the external actuating device is an outside door handle situated on the exterior of the door.

10. (canceled)
